(19) United States
(12) Patent Application Publication
(10) Pub. No.: US 2009/0158141 A1
(43) Pub. Date: Jun. 18, 2009

(54) METHOD AND SYSTEM TO SECURE THE DISPLAY OF A PARTICULAR ELEMENT OF A MARKUP FILE

(76) Inventors: Frederic Bauchot, Saint-Jeannet (FR); David Loupia, Carros (FR); Gerard Marmigere, Drap (FR); Joaquin Picon, Laurent Du Var (FR)

Correspondence Address: HOFFMAN WARNICK LLC, 75 STATE ST, 14 FL, ALBANY, NY, 12207, US

(21) Appl. No.: 12/331,727

(22) Filed: Dec. 10, 2008

(30) Foreign Application Priority Data
Dec. 18, 2007 (EP) 07301696.6

(51) Int. Cl. G06F 17/00; G09G 5/02

(52) U.S. Cl. 715/239; 345/589

(57) ABSTRACT

A method and system to secure the display of a particular element of a markup file, interpreting a markup file comprising displayable elements, converting the displayable elements of the markup file to at least one image and constructing a modified markup file including the at least one image and a scripting language code adapted to encode links and input fields associated to the image.

### FIELD OF THE INVENTION

The present invention relates generally to data processing, and more particularly to systems and methods for web browsing.

### BACKGROUND ART

The business model of many companies on the Internet mostly depends on advertisements displayed on a client web browser. The rise of solutions enabling the blocking or skipping of such ads greatly endangers this mainstream source of revenue.

Advertisements represent a major source of revenue for many websites and companies. In the case in which ads are massively rejected (and even “well targeted”, effective or informative ads of major companies), there will not be free content or services anymore. For now, only the most technically proficient users are aware of such ad blocking techniques but a default integration of such tools in mass-market web browsers would result in huge losses for companies whose business model rely on advertisements. It is then of the highest importance to be able to find a way to secure the display of advertisements on web browsers and to avoid the possible death of advertising in today's digital networks and their associated ever growing ad blocking capabilities. Indeed, a complete shift away from advertising threatens, with the growing use of ad blocking techniques (so called adblockers or ad blockers).

Advertisements are text areas, still images, animated images, or even videos embedded in web pages. When a member of the advertising audience (referred to as a “viewer” or “user” without loss of generality) selects one of these ads by clicking on it, embedded hypertext links typically direct the viewer to the advertiser's web site (“click-through” process).

It appears that more and more consumers are tired of intrusive marketing. They are saturated by highly distracting ads, though some industry players try to leverage “non-annoying” and “informative” ads. Indeed, there are very few simple, easy to read, non-intrusive, text advertisements. Instead, ads are often flash or animated gif banners that users feel to be too invasive (pop-ups, pop-unders, and the like sometimes cover the desirable contents) and flashing graphics make it very hard to read real text elsewhere on the page. Further, most of the time ads that are delivered are not appropriate (so-called targeted ads often fail) and distract the reader with noise. Most of the time, the targeting of users implies the tracking of habits and threatens privacy.

For all above reasons, more and more users use so-called adblockers (or ad blockers). From the users' point of view, adblocking benefits include cleaner looking web pages, lower resource-usage (bandwidth) and the faster loading of pages (many pages are designed to load heavy ads first). The state of the art comprises many adblocking techniques enabling the skipping or removal of advertisements on web browsers, such as pure text browsers, pop-up blockers (or pop-under), blacklists of URLs of ad servers, text filtering tools (based on keywords, to prevent ad files from loading), script blockers, use of CSS rules (to hide specific HTML and XHTML elements), etc.

Adblocking techniques are not solely involved. The use of extraction techniques for building personalized web pages, the use of RSS and the use of mashups also induce the skipping of advertisements. The use of personalized web pages enables the extraction of precise content areas and the gathering of this extracted content in personalized pages. Thereafter, the user does not need to visit the original page again, thus skipping advertisements. if any. Another technique relies on loading entire pages and displaying them only with frames and/or <DIV> tags, hiding unwanted contents. This last possibility also presents the drawback of leaving the number of unique visitors unchanged (from the advertiser's point of view), though the content is not even displayed to the user. With RSS feeds (RSS stands for “Really Simple Syndication”), similar mechanisms do operate. Indeed, the rise of RSS feeds has deeply changed the nature of the Internet, which isn't anymore a stock of data but flows of data. It is important to notice that according to this RSS model, content providers do control feeds, meaning they can choose what content to offer to their subscribers, through RSS feeds. Again, thanks to emerging mechanisms, it is now possible for users to freely extract parts of web content, without any limitations. In other words, web users do not need to visit bottleneck pages anymore (home pages or portals containing lots of ads). In this context, content providers may be reduced to providers of raw data, with very few choices for monetizing their business. For example, a technique (sometimes called RSS Generator) enables the extraction of feeds from any web page. Yet other techniques allow not only to gather RSS feeds, but also to combine them (RSS remixer tools enable filtering, searching, mixing, etc). There have been some attempts to embed targeted ads into syndicated feeds (an ad would be served in an RSS item or blog post containing keywords that an advertiser has pre-selected) but text filtering (keywords-based—or involving other techniques) can bring this to defeat too. At last, the use of so-called mashups also poses a threat to online advertising. Thanks to APIs (Application Programming Interfaces), applications themselves can also be aggregated. And in particular, advertisements can be removed during the remixing of content.

On the reverse side (i.e., secure the display of advertisements), it appears that there are very few technical solutions available. A known approach consists in URLs address scrambling techniques, in order to bypass URLs blacklists. This solution is not efficient because of the reactivity of possible collaborative filtering (like peer-based anti-spam techniques). The use of randomized addresses also induces limitations (learning capabilities). Aside from this common technical approach, there are only non-technical methods. For example, permission marketing methods are tested (indeed, users may target ads instead of ads targeting users), but these methods do not apply well to mass markets. Other methods based on users profiling have been tried by advertisers or their partners to deliver better perceived forms of advertisements, but it poses privacy threats. If no reliable solution emerges to secure the display of advertisements, advertising formats may evolve to these contextual, interactive, permission-based and targeted messaging to retain the attention of consumer and to help minimize both irritation and “tuning out.” A few content or service providers also try to warn their users on damages implied by the use of adblocking techniques by arguing that it takes revenue away from the people that work hard to provide them content and services. Sometimes they require a specific license agreement for visiting their websites. In conclusion, none of these (non-technical) methods succeed to effectively act as countermeasures to adblocking techniques and/or the use of RSS feeds and/or the use of personalized web pages, and in fine, to secure revenues streams.

In view of the above, there is a need for a method enabling to secure the display of advertisements on web browsers, and more generally for markup file viewers.

### SUMMARY OF THE INVENTION

The present invention provides a method and system for securing the display of a particular element (such as an advertisement) of a markup file.

Among many advantages, the present invention defeats any image recognition technologies and defeats any semantic or text analysis, which technologies could possibly be used to block or skip advertisements, in addition to providing an absolute protection against malicious software.

Indeed, a very first advantage of the present invention lies in its ability to secure the display of advertisements, because it defeats semantics technologies (ineffective on images) and exploits image recognition technologies' limitations (advertisements enclosed in larger images are not detectable). It should be noted, however, that the present invention is not solely directed toward advertisements. Indeed, the present invention addresses every situation wherein the display of a particular area (such as text or graphics) needs to be secured (need for preserving the integrity of displayed data). This will be further discussed.

An indirect benefit of the present invention lies in its ability avoid any execution of malicious code (if any) both for the proxy server and the web browser. The Internet today is infested with dangers, among which is malicious software code. A user visiting a web page with a web browser can inadvertently execute malicious code, endangering the user's local machine (immediately or in the near future). The generic malicious code may comprise a virus, Trojans later downloading and installing keyloggers, spyware, etc. Private and financial data are then at risk, and the hardware device can also be physically damaged, if not remotely used for illegal purposes. It is then very valuable to be able to safely browse the Internet. Indeed, the two-tier architecture enables malicious code execution to be avoided on the browser side (the web browser does not receive anymore markup pages with unreliable code, but only very simple markup scripting language and images) while the use of virtual machines secures the proxy (the virtual machine is disconnected from the host machine; for example, dynamic links libraries (dll) cannot be modified, virtual machine act like a so-called sandbox).

Quite surprisingly, malware and advertising are tied: malicious code is said to be massively injected through online advertising, due to the complex structure of business relationships (injection of malicious content into legitimate advertising delivery streams). The present invention secures the display of advertisements and at the same time avoids malicious code execution. The web browser has the guarantee not to execute any malicious code while the content provider has the guarantee to secure its advertisements. It is a win-win operation that opens many interesting business opportunities.

Another advantage is that it only requires a standard browser. It does not require any additional plug-in, components or local software on the client side. No additional software is required on top of the web browser. The present disclosure is thus the first approach that works without browser modifications (use of unmodified browsers). It can be used directly in today's browsers, hence adoption can be immediate.

Yet another advantage is it enables fast and low cost internet access. It reduces the weight and complexity of an incoming markup file for the web browser (it reduces possible bugs or error contained in code elements). Today, many of devices (mobile phones, tablet PCs, etc.) have limited CPU capacities. Because modified markup files only contain image files (in addition to scripting language code which is not malicious), browser or viewers running on such devices almost only need to be able to display images. It thus enables remote browsing for mobile devices with limited computing and memory resources.

Further advantages of the present invention will become clear to the skilled person upon examination of the drawings and detailed description. It is intended that any additional advantages be incorporated therein.

### BRIEF DESCRIPTION OF THE DRAWINGS

Embodiments of the present invention will now be described with reference to the following drawings.

FIG. 1 shows the displayable elements and the scripting language code of a markup file.

FIG. 2 shows the general principle of the invention.

FIG. 3 shows operations on the proxy.

FIG. 4 details the use of map areas and input map areas generation.

FIG. 5 provides an example of the map areas and input map areas generation.

FIG. 6 illustrates the conversion of an interpreted markup file to an image.

FIG. 7 illustrates various sub-images generation modes.

FIG. 8 summarizes modifications brought to a markup file.

FIG. 9 illustrates architecture options.

### DETAILED DESCRIPTION OF THE INVENTION

To facilitate description, any numeral identifying an element in one figure will represent the same element in any other figure.

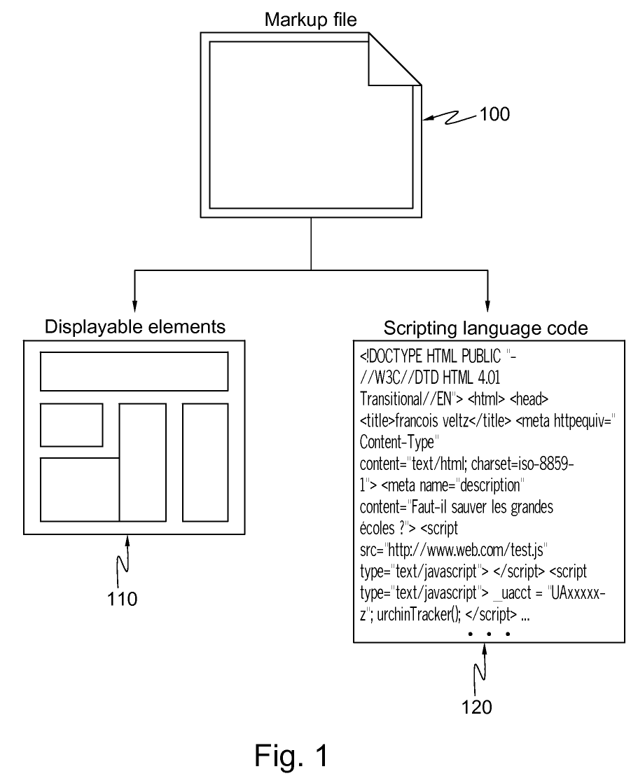

FIG. 1 shows the displayable elements and the scripting language code of a markup file.

Reference is now made to FIG. 1. According to a certain embodiment, FIG. 1 shows the object that will be modified and used according to an embodiment of the present invention.

FIG. 1 shows a markup file (100) which comprises a set of displayable elements (110) and a scripting language code (120). The markup file (100) is usually a binary file but it can exist in a formatted nature. It is usually transmitted over networks and/or retrieved locally in memory, and may be generated locally, entirely, or in parts. In an embodiment, the markup file (100) is an HTML file. Web pages indeed include (displayable) content, and instructions or embedded information (such as meta information, hyperlinks addresses, scripts, etc.).

The determination of displayable elements (110) can be considered relative or absolute. The determination is said to be relative when resulting from the interpretation by a viewer. For example, a set of displayable elements of an HTML markup file will be determined by loading and executing the markup file in a web browser (or web browser instance). It is observed that different web browsers may lead to different interpretations (and thus different sets of displayable elements), although there is a convergence between the different interpretations performed by web browsers existing on the market. In this sense, the interpretation is considered relative. Another approach would integrate the different behaviors of web browsers into a common rendering model (absolute interpretation). In brief, these displayable elements are all elements that will reach the user's eyes or that are useful to this final display. Displayable elements (110) thus can be elements, such as images, videos areas, and text areas. The “displayable elements” expression is intended to cover elements that will be seen by the user in the end. Consequently, it covers cases including possible further operations (such as filtering or masking) that may happen after the operations performed by the described method.

Regarding the scripting language code (120), it is observed that the expression “scripting language code” designates all instructions or lines of software code comprised in the markup file (100). In detail, it comprises all suites of characters forming instructions understandable by the machine by/for executing said markup file. In other words, it comprises all data that is not intended to be directly seen by the final user or viewer of the markup file (such as scripts or meta data for example). In addition, it also comprises all data that are indirectly useful for the display of displayable elements (for example <DIV> HTML tags). The scripting language code (120) is often enclosed in the markup file (or can be associated with it and further retrieved). Code elements are usually enclosed in the markup file, but not always. Indeed, modern programming techniques may use the dynamic retrieval of code programs. Consequently, in some situations, it may be necessary to retrieve pieces of code elements, dynamically associated with the set of code elements originally enclosed the markup file. For example a user action in the browser may imply a further modification of the markup file (by retrieving new instructions from the server, or by accessing local resources, for example through “Xinclude” which defines the ability for XML files to include all or part of an external file). For this reason it is necessary to first execute the markup file.

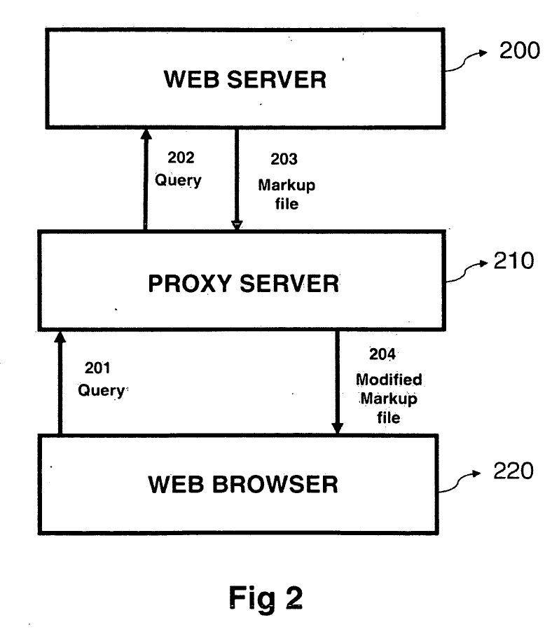

Reference is now made to FIG. 2, which shows the general principle of the invention in accordance with an embodiment.

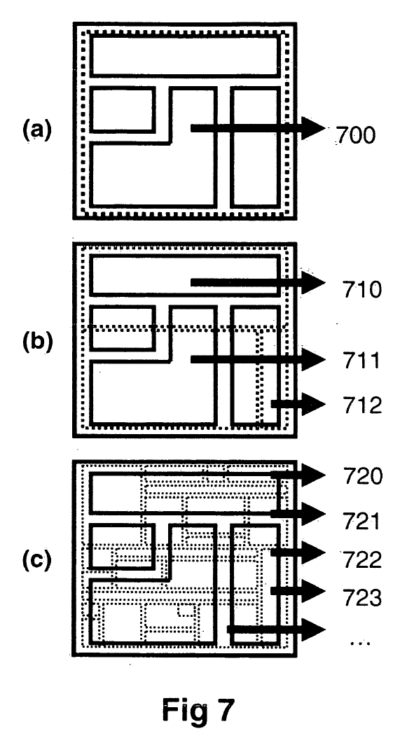

According to a certain embodiment, FIG. 2 shows a web server (200), a proxy server (210) and a web browser (230). FIG. 2 shows an example in which the query of the web browser (230) is received (or intercepted, see FIG. 7) at step (201) by the proxy server (210). The proxy server (210) transmits through a network (not shown) the query to the web server (200) at step (202). In response to the query (202), the web server transmits through a network (not shown) a markup file at step (203). The proxy receives the markup file and operates a series of operations with the markup file (which will be described in the following figures) and finally transmits at step (204) through a network (not shown) a modified markup file to the browser (230). The web browser (230) executes the modified markup file.

FIG. 2 is only provided as an example. Many options and alternatives will be further discussed. In particular, there can be one or a plurality of networks involved, which can change over time and can be of different nature (RTC, ADSL, Fiber, T1, Wimax, UMTS, Wifi, etc), using different protocols.

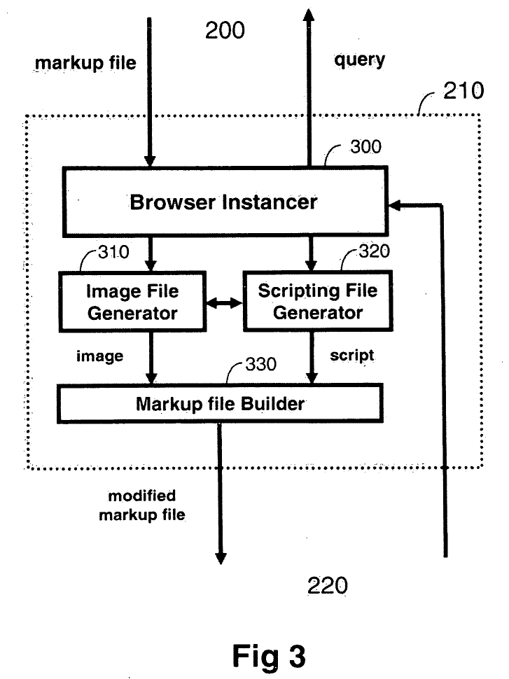

Reference is now made to FIG. 3, which shows operations on the proxy. According to a certain embodiment, the figure shows a browser instancer (300), an image file generator (310), a scripting file generator (320) and a markup file builder (330).

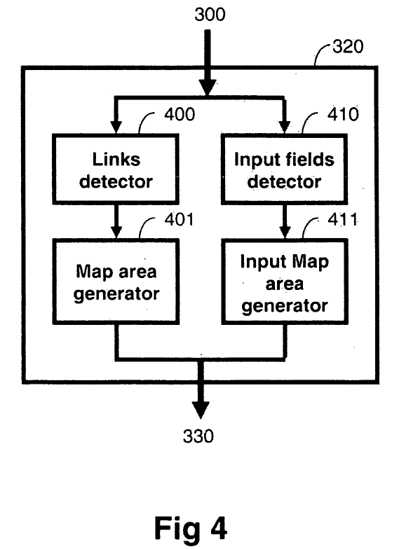

A markup file served by the web server (200) is received (or intercepted) by the browser instancer (300). The browser instancer (300) interprets the markup file (i.e., the markup file code is interpreted in a browser for example; the markup file is then parsed and displayable elements are defined). The browser instancer (300) transmits the set of displayable elements to the image file generator (310) (i.e., it transmits displayable elements as well as the layout of these displayable elements). The browser instancer (300) also transmits the parsed code of the markup file to the scripting file generator (320). The image file generator (320) renders one (in one embodiment) or a plurality of images from the displayable elements (110) and the scripting file generator (320) outputs a new scripting language code from the scripting language code from the browser instancer (300). The new scripting language code is described in FIG. 4. It is observed that said code also encodes the relative positions of the plurality of images having been generated (if a plurality of images have been rendered). It should be noted that the image file generator (310) and scripting file generator (320) can optionally interact with each other (for example if a plurality of images have been generated, this may be reflected in the scripting language code). The markup file builder (330) then builds a modified markup file with the new scripting language code of the scripting file generator (320) and the image(s) being generated by the image file generator (310). The modified markup file is then transmitted to the web browser (220). The web browser (220) interprets the modified markup file.

According to certain embodiments, it is observed that the modified markup file can exclusively contain addresses of content servers (URLs of external web servers, i.e., which do not implement the described method) and in this case, the web browser will query directly these content servers when interpreting the modified markup file (HTTP GET requests for example). This is an open system. For example, a scenario of such a use of the described method corresponds to a one-shot way, “on-demand”, to secure the display of a web page. However, according to other embodiments, the modified markup file also can exclusively comprise addresses of proxies implementing the described method and in this case, the proxies would be further adapted with address-translators for retrieving requested contents. This is a closed system, forcing the web browser to query only proxies implementing the described system. Once a web browser has queried such a proxy, it is trapped and will only see reengineered contents (by the present method or others). A last possibility, in yet another embodiment, is to have the modified markup file containing both addresses of content servers (for direct queries) and proxies (for indirect queries). These three possibilities depend on a policy to be determined (policy to decide whether the described system is closed or opened; or at what point it is partially opened or closed).

It is also observed that while the original markup file (203) served by the web server (200) contains a set of displayable elements (110) and an original scripting language code (120), the modified markup file (204), outputted by the proxy server (210), contains one or a plurality of images generated by the image file generator (310) and a new (and light) scripting language code generated by the scripting file generator (320). This scripting language code does not contain any malicious code, which is an indirect advantage of the present method and system. Simply said, parts of the markup file comprising potential malicious code can be removed (an unsafe markup file can be translated into a safer markup file), while user interactivity is preserved.

Regarding the scripting language code generated by the scripting file generator (320), it is observed that, according to certain embodiments, relative positions of image files having been generated may be part of the scripting language code generated by the scripting file generator (320).

According to a certain embodiment, the scripting language code generated by the scripting file generator (320) can be further adapted to re-encode links and input fields for only a subset of displayable elements of the markup file. In other words, the user interactivity will be maintain possible for some areas and will be forbidden (not existing) for other specific areas. This variation is very valuable because of the control it offers over the user interactivity. The present invention thus can provide a control over the user interactivity present in the interpreted markup file, which can be modified: the interactivity can be leaved unchanged, partly changed or completely removed. In other words, each link and input field can be re-encoded with described tags, or not. This provides much flexibility.

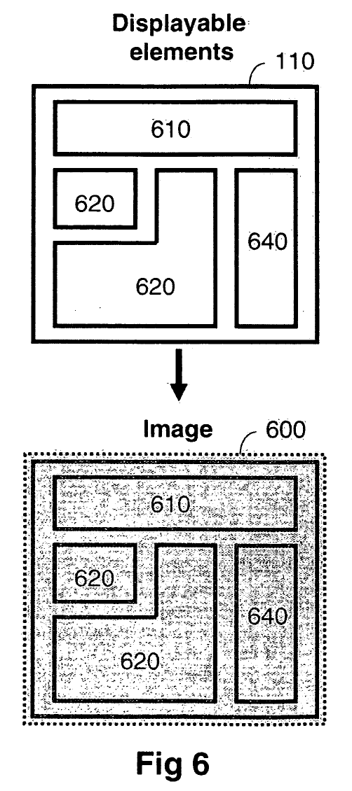

As per the generation of images, as further described with regard to FIG. 6. It is observed that in the closed system described above, according to certain embodiments, there is disclosed a type of mirroring between the instance running in the web browser and the instance running in the browser instancer (300). Such a mirroring enables further possibilities. In the case where the markup file is an HTTP markup file, when an HTML request is performed, information about the browser itself is transmitted (type, colors, resolution, etc.). Usually, this sort of fingerprint is transmitted once, but this information can be retrieved on a regular basis. With script code for example, it is thus possible to analyze the resolution of the page and to accordingly render the image files (by resizing the image(s)). According to a certain embodiment, the images generated by the present invention can be of the same size than those of the displayable elements of the original markup file. However, they also can be larger or smaller, depending of the display area of targeted viewer or browser. In the case where image files are larger than the display area of the targeted viewer or browser, the targeted viewer or browser will use standard scrolling options to display the complete image of the original markup file.

According to certain embodiments, depending on web browsers, the image rendering of displayable elements of markup files can be slightly different. In principle, HTML is a standard and then the rendering of the final HTML page is consistent among browsers available in the market. However, in practice, there may be differences between the different renderings performed by different web browsers. The disclosed operations can be directed to take into account these differences.

Reference is now made to FIG. 4, which illustrates the use of map areas and input map areas. FIG. 4 shows an example of the scripting file generator (320). It comprises a links detector (400) and an input fields detector (410). It also comprises a map area generator (401) and an input map generator (411).

According to a certain embodiment, the scripting file generator (320) receives a markup file from the browser instancer (300) and outputs a scripting language file to the markup file builder (330). In the example, the scripting language code of the incoming markup file is analyzed by both the links detector (400) and the input fields detector (410). This analysis can be sequential or parallel. The links detector (400) detects links in the markup file and transmits said links to the map area generator (401). The map area generator (401) generates a scripting language code. The input fields detector (410) detects input fields in the markup file and transmits said input fields to the input map area generator (411). The input map area generator (411) generates a scripting language code. Both scripting language codes generated by the map area generator (401) and the input map area generator (411) are gathered into one unique scripting language file, which is transmitted to the markup file builder (330).

According to another embodiment, the following section describes operations when the markup file is an HTML or XML file. It is reminded that SGML is a language for describing markup languages. HTML (Hyper Text Markup Language) is a language defined in SGML. HTML specifies a small set of structural and semantic tags suitable for authoring relatively simple documents. HTML adds support for hypertext and multimedia capabilities. HTML documents are text files made up of HTML elements. HTML elements are defined using HTML tags. HTML tags come with their attributes. An attribute is a parameter to an element declared in a DTD (document type definition, a collection of XML markup declarations; an attribute's type and value range, including a possible default value, are defined in the DTD). Syntactically an HTML element is thus constructed with a start tag, any number of attributes (and their associated values), some amount of content (characters and other elements) and an end tag (which is often optional); an empty element has no content and requires no end tag. There are a few W3C unofficial elements which may be ignored or displayed improperly on browsers not supporting them. XHTML (or (X)HTML) documents are XML conforming. XML is the short name for Extensible Markup Language. XML documents do not carry information about how to display the data. Without using CSS or XSL, a generic XML document is rendered as raw XML text by most web browsers. In order to style the rendering in a browser with CSS, the XML document must include a reference to the style sheet.

To summarize, when the markup file is an HTML or XML file, code elements to be parsed, detected, filtered out and transcoded are (X)HTML elements, which are sometimes informally referred to as “tags”. Code elements can be such as: text (paragraphs, lines and phrases), lists (unordered, ordered and definition lists), tables, links (hypertext and media-independent links), objects, images, applets, style sheets (alignment, font styles, etc.), frames, forms (user input, text fields, buttons, menus, etc.) and scripts.

According to a certain embodiment, when the markup file is an HTML or XML file, the links detector (400) detects links in the markup file. For example, it detects all occurrences of the string <a href=“URL”>. With these detected occurrences, the map area generator (401) generates a scripting language code that is associated with the image having been rendered by the image file generator (310). In fact, it re-encodes the detected links with <USEMAP>, <MAP> and <AREA> tags, associated to the rendered image of the image file generator (310). In HTML, <USEMAP>, <MAP> and <AREA> are tags that allows to define clickable areas associated to an image. <USEMAP> is an attribute of the tag <IMG> and allows to associate actives areas to the image. <MAP> defines a container that comprises the definition of a plurality of active areas. <AREA> defines the active area on an image file. Attributes of the <AREA> tag are “SHAPE” (it defines the form of the area such as rect, circle, poly and default), “COORDS” (it allows to define the position of the associated active area within the image), “HREF” (it associates an URL link to the area, and “ALT” (it displays a default text if the image isn't retrieved).

The input fields detector (410) detects input fields in the markup file. For example, it detects occurrences of strings such as <INPUT>. Indeed, HTML defines control types such as buttons, checkboxes, radio buttons, menus, text input, file select, object controls, etc. With these detected occurrences of input fields, the input map area generator (411) generates a scripting language code that is associated with the image having been rendered by the image file generator (310). In fact, it re-encodes the detected input fields with a new tag <INPUT AREA>, which is associated to the rendered image of the image file generator (310). The new tag <INPUTAREA> allows associating an input field to an image. The associated attributes to the tag are “Shape”, “Coords”, “Type” which defines the type of input field or associated action (radio button, checkbox, text input, select box, password input, submit, reset), “Var” (which defines the name of the input field (text/password) or a Boolean value (radio button/checkbox)—initialized with a specified value or typed string of characters), “Default” (for the default value of the input).

According to a certain embodiment, the markup file builder (330) then builds a modified markup file with the new scripting language code of the scripting file generator (320) and the image(s) being generated by the image file generator (310). The modified markup file is then transmitted to the web browser (220). The web browser (220) interprets the modified markup file. Upon a click of a user-controlled cursor on an area corresponding to a <INPUTAREA> tag in the modified markup file generated by the markup file builder (330), the browser will send a list of data to the specified server.

According to certain embodiments, it is observed that the coordinate information of the detected links and input fields in the HTML page are known and reused in attributes of the above tags: the browser interpreting the HTML page establishes a correspondence between the links in the scripting language code and their relative position in the displayed HTML page.

It is also observed that creating a new tag requires the parser of the browser to modified (to be executed, a tag has to be known by the parser of the browser). If the source code can be accessed, an add-on may be able to rewrite said parser, thus enabling a transparent implementation of the present invention. Standardization organizations may also accept the new tag as a standard (browsers and their parsers then would implement such an <INPUTAREA> tag). At last, it is observed that there are ways to implement such a described functionality but without the need for a new tag (by using other existing technologies, such as applets or scripts). In conclusion, the advantage according to which there is now additional software needed on top of the browser is still valid.

In conclusion, there is described a method of handling an interpreted markup file including input fields and links (comprising a set of displayable elements and an original scripting language code, including input fields and links), converting the set of displayable elements of the interpreted markup file to an image, identifying at least one of said input fields or links and replacing the original scripting language code by a modified scripting language code, said modified scripting language code being obtained by converting at least one said link into markup tags or by converting at least one said input field into a markup tag associating at least a part of said image to a input field.

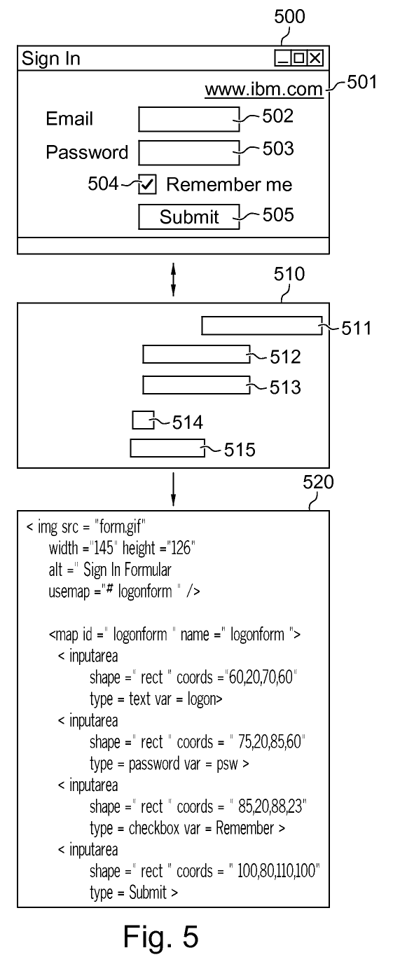

Reference is now made to FIG. 5, which shows an example of the generation of map areas and input map areas. According to a certain embodiment, FIG. 5 shows a particular part of an interpreted markup file (500), an image (510) and a representation (520) of the scripting language code associated with the image. It shows how an HTML formular can be managed according to certain embodiments of the present invention.

The particular part of an interpreted markup file (500) is illustrated as being a formular, for example comprising an URL link (501), two text input fields (502 and 503) for email and password. A notch box (504) for the classic “remember me” functionality, as well as a “Submit” button (505).

The image (510) rendered by the image file generator (310) is represented. It comprises subareas of the image that will be used by <INPUTAREA> tags: the image area (511) which corresponds to the URL link, the image areas (512 and 513) which correspond to the two text email and password input fields, the image area (514) which corresponds to the notch box, as well as the image areas (515) which corresponds to the “Submit” button.

The graphics (520) is a representation of the scripting language code, associated with the image (510). The gathering of the scripting language code and its associated image enables to construct a modified markup file.

Reference is now made to FIG. 6, which illustrates the conversion of an interpreted markup file to an image. FIG. 6 shows an example of displayable elements of a markup file.

Interpreting (or rendering) a markup file in a viewer or a browser defines (or renders) the displayable elements of the markup file. In the proposed example, the markup file (100 or 203) comprises many distinct displayable elements (110), such as a horizontal advertisement banner (610), a right column for a menu comprising URL links (640), a video object area (620) and a text area (620).

The image (600) generated by the image file generator (310) is shown. The image acts like a background image. A user cannot select, copy and paste text from the text area (620) anymore. The menu area (640) is likely to be re-encoded with above described tags. According to a certain embodiment, the scripting language code (of the original markup file) associated with the video object (620) can be isolated, slightly modified (for new coordinates position) and enclosed in the modified markup file (processing this way, the image (600) will remain in background and will be covered by the video display in the foreground, and the video will still play). And in particular, for example, the horizontal advertisement (610) banner will be enclosed in the global image (600) and following all known adblocking techniques will fail (please see further explanations).

Reference is now made to FIG. 7, which illustrates various image generation modes. According to a certain embodiment, FIG. 7 details various modes of image generation. Indeed, displayable elements of a markup file can be converted into one (FIG. 7a) or a plurality of images (FIG. 7b and FIG. 7c) in many ways. In other words, according to certain embodiments, the image can be further divided into a plurality of sub-images.

It should be noted that, according to an embodiment, generating a unique image is sufficient to secure the display of advertisements while being fast and easy to achieve. According to other embodiments, generating a plurality of images from this single image is not mandatory, it only reinforces the robustness of the method and system. It is also observed that any similar image generation, modification or combination, is included in the scope of the present disclosure. As shown in FIG. 2 for example, the image file generator (310) renders one or a plurality of images (sub-images) from the displayable elements (110) of a received markup file (203).

FIG. 7a illustrates the case wherein a unique image (700) is generated (represented in dotted line); it may be considered as a “background” image. According to a certain embodiment, this image captures what is what is displayed to the user. This can be achieved using several techniques, for example by accessing the video buffer (most of the time, the operating system itself does provide such a feature).

FIG. 7b illustrates the case wherein the displayable elements are converted into a plurality of sub-images (710, 711, 712), eventually in a disposition which does not correspond to (or duplicates) the original arrangement of displayable elements. For example, the sub-image (710) comprises pixels of many distinct displayable elements (110): pixels of the horizontal advertisement banner (610), pixels of the right menu (640), pixels of the video object area (620) and pixels of the text area (620). This greatly secures the display of the advertisement banner (610) (image recognition becomes more difficult). According to certain embodiments, such an “image mapping” can be easily obtained from the image (700).

FIG. 7c illustrates a further case wherein the displayable elements (image (700)) are converted into a very high number of sub-images (720, 721, 722, 723, . . . ), eventually involving random (ever-changing and complex mapping), and be they adjacent or superposing images. Overlap between images indeed remain possible and even wishful.

According to different embodiments, the image (700) or one or a plurality of sub-images (710, 711, 720, 721, 722 . . . ) can be further modified or altered by operations such as convolution operations, morphological operations, geometric operations, histogram operations, alpha compositing operations, etc. It is an advantage of the present invention to defeat text analysis tools (semantics, OCR, etc.) as well as image recognition tools (pattern matching, edge points, etc.). For example, each generated image file can be cropped, blurred, encoded in a rare format, transformed into a black and white image, distorted, etc. Noise can also be added to the image or sub-image. It is underlined that described operations (such as divisioning, splitting, partitioning, gathering, grouping, distorting, noising, discretizing, resampling, scrambling, greyscaling, etc.) on the image file or image files derived from the displayable elements of the markup file can be combined in many ways, the operations aiming at enforcing the robustness of the proposed mechanism against possible adblocking techniques. In particular, according to different embodiments, the above operations can be applied to the totality of displayable elements or only selectively to a subpart of these displayable elements. Yet, a compromise has to be found between readability for the final user and greater difficulty to analyze and block the resulting image. Readability scoring systems can help to perform these operations.

Certain advantages of such a generation of images will now be discussed. The outstanding advantage of such an image generation process is allows to secure the display of advertisements enclosed in markup files. Indeed, it defeats all techniques used by so-called adblockers, among which text analysis techniques and image recognition techniques. Because displayable elements containing text have been rendered into an image, no semantic or text filtering tools will be later able to perform any analysis. The comprehensible data for these tools has been simply erased. Still, one might try to perform an OCR analysis (analyzing the image to extract enclosed text), but these tools are very sensitive the quality of the image and do consume a lot of computing resource. An adapted image modification will easily defeat this possibility (by adding noise or by distorting slightly the image, seeking for a compromise between readability for the user and added complexity for OCR or other analysis tools). As per image recognition technologies, they are at very early stage. One might try to isolate image areas from texts areas, and then apply image matching techniques (i.e., comparing isolated images with databases of known advertisement images, to decide whether said isolated images are advertisement images or not). It appears that it is difficult, if not impossible, to detect an advertisement image enclosed in another larger image. The more the surface of the advertisement image is small compared to the total surface, the more image recognition (or matching) performs badly. An ad enclosed in a 110% image would be more easily detected and recognized than an ad enclosed in a 400% image (recognition dramatically falls at the threshold 25% in average). Even advanced image recognition technologies, like the so called pattern matching technique (aiming at automatically isolating objects of interest within an image by using edge points detection and other techniques) also fail in practice. Like the use of text analysis techniques, these image recognition technologies are too CPU and memory intensive and thus fail to provide a good solution in real-time or intensive environments. The same analysis can be conducted to product placement in movies (detecting and deleting a brand apparition in a movie will remain impossible for many years)

In FIGS. 7a and 7b, the advantage stems from the difficulty to isolate homogeneous areas and consequently to perform efficient image recognition techniques. In FIG. 7c, the advantage comes up from the difficulty of gathering adequately images to perform image recognition techniques and text/Optical Character Recognition analysis.

Rendering displayable elements into one or a plurality of images thus introduces many advantages. According to a certain embodiment, depending on an adequate intelligent “image mapping”, the robustness of the system to adblocking techniques can be optimized and the display of advertisement can be greatly secured. Given one or a plurality of areas to be secured, one or another image generation mode will be chosen. In other words, knowing the area where the advertisement is placed (according to data provided by the advertiser for example), it is then possible to optimize the image mapping so that image recognition techniques present the lowest possible performance. Such a feature allows interesting business models, since advertisers can pay for additional services (precisely for securing the display of their specific advertisements, for example). It also enables to prioritize the display of image files (transmitting images in a sequence according to a display priority; for example the generated image file containing the advertisement could be displayed first; such a feature can be useful when considering bandwidth parameters, etc.).

In conclusion, there is provided a further technique of altering one or a plurality of images by distorting, greyscaling, re-encoding, resizing, noising, discretizing, resampling or scrambling. It is advantageous when combined with the described content re-encoding mechanism.

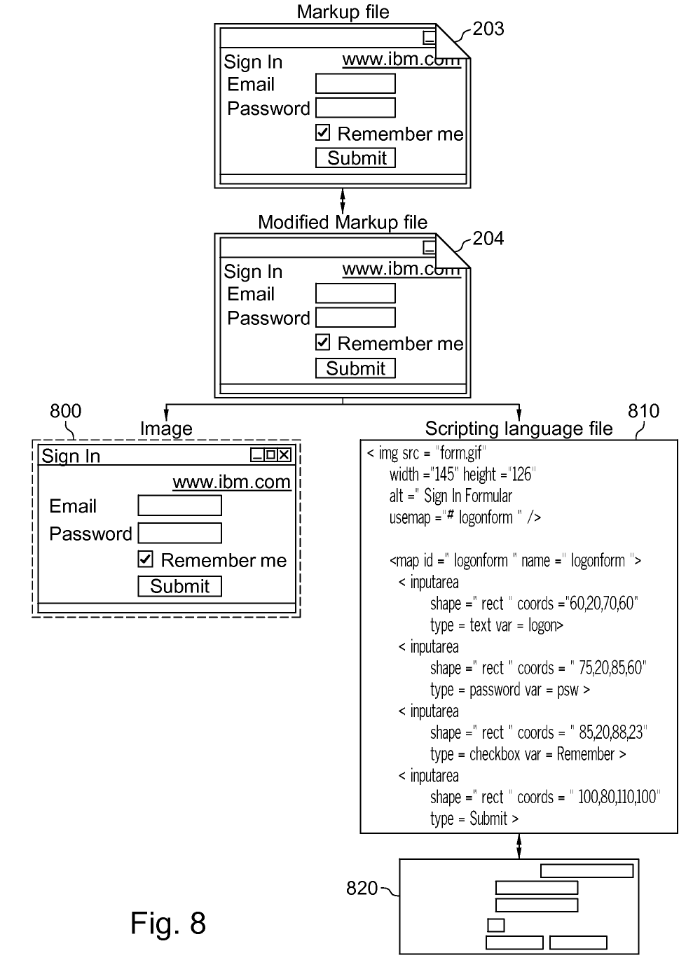

Reference is now made to FIG. 8, which summarizes modifications brought to a markup file according to a certain embodiment. FIG. 8 depicts a markup file (203), a modified markup file (204), an image (800), a scripting language code (810) and a representation (820) of active areas associated with the image (800).

A global overview of a certain embodiment of the present invention is now discussed. An original markup file (203) comprising an original scripting language code is modified into a modified markup file, which comprises an image (800) and a modified scripting language code (810). The image corresponds to the capture of the displayable elements of the original markup file (when interpreted in a browser or viewer). The scripting language code (810) is associated with the image (800).

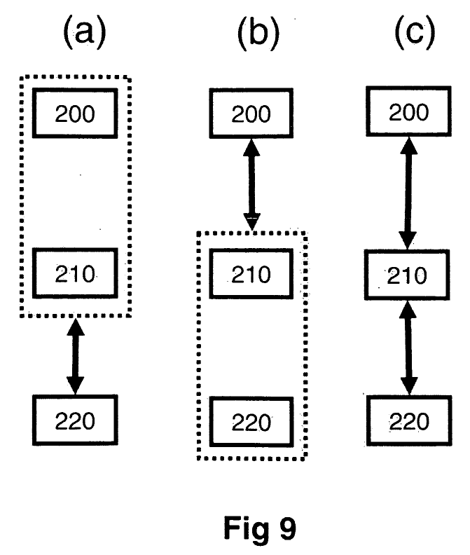

Reference is now made to FIG. 9, which considers architecture options and alternatives.

The present disclosure shows a two-tier architecture, wherein the proxy server performs steps of the present invention (image generation and reengineering of the scripting language code). But the implementation of the proposed mechanisms can be made according to many more possibilities that will be further discussed.

Introductory considerations about proxy and the economy of browsers are required. Browsers can be broadly understood as “viewers”. A browser is designed to render markup files into displayable elements for the user and to execute code elements. Indeed, web browsers are software programs installed on desktop computers or mobile devices and adapted to execute script programs, parse and display web pages. From technical and legal points of view, some web browsers are open source and others are proprietary. This distinction between open source and proprietary is important, because proprietary software enables to control software code developments, which is not the case with open source software. For example, proprietary media players can forbid fast-forward, thus forcing users to watch video advertisements (in general located at the beginning of video files). With open source software (i.e., accessible and modifiable software code), this is not possible anymore, since software code can be changed to enable advertisement skipping. More generally, this is true for any DRM (Digital Management Right) system, which necessarily requires at least a portion of closed software code (protection by secret as opposed to open source code which is available to anyone). In theory, proprietary browsers would be capable of selectively enabling advertisement blocking (no specific add-on available, etc.). The case of open source web browsers is more simple, since forks can emerge anytime, allowing such specific add-ons. Another important aspect of advertising blocking economy is business interests. A well known open source browser is largely funded by a major advertising company (and thus has little incentive and interest in enabling a default integration of ad blockers in its browser). However, forks (modified distributions of said open source browser) could emerge at any time. Proprietary web browsers could possibly selectively enable some advertisements and disable others, according to their own interests or agreements. For example, it might be technically possible for a given browser to block some advertisements and to allow only those of its own platform. For all these reasons, the use of a proxy server performing steps of the present invention is very valuable (but not mandatory).

FIG. 9 shows, according to a certain embodiment, a web server (200), a proxy server (210) and a web browser (220), in various configurations. Logically, the proxy server (210) is located between the web server (200) and the web browser. Physically, the proxy server (210) and the web browser (200) can be running on the same physical machine as shown on FIG. 9a. FIG. 9b shows a situation wherein the proxy server (210) and the web server (200) run on the same physical machine. FIG. 9c shows the last situation wherein the web server (200), the proxy server (210) and the web browser (220) run on three different physical machines.

Since a proxy is usually hardware-implemented, it can also be software-implemented. Consequently, steps of the present invention can be implemented partly in the web browser (220), partly in the proxy server (210), partly in the web server (200) (or a combination).

According to certain embodiments, since the proxy server will see all queries of the web server (account numbers, passwords and visited pages of the web browser will be transmitted to the proxy server through the web browser queries), it is highly recommended that the proxy be run by a trusted party (unless anonymization mechanisms are used). Authentication mechanisms may be used (ranging from a strong authentication to a simple registration; hash values may be used for the delivery of image files).

From the following description, it will be assumed that all operations of the present invention are performed by the proxy server (210).

FIG. 9a is anticipated to be a simple and easy implementation, because of agreements between administrators of the web server (content provider) and advertisers. The web browser has nothing to tell about this mode of implementation (operations performed will be transparent, i.e., the browser will only receive modified markup files, while queries will be easily intercepted by the proxy server). The advantage of such configuration is that the web browser has the guarantee not to execute any malicious code while the content provider has the guarantee to secure its advertisements. It is a win-win operation that opens many interesting business opportunities.

FIG. 9b illustrates a further possibility, according to other embodiments of the present invention. The program implementing the present invention can be executing in a superior level than the web browser (operating system for example). Or it can be implemented in the form of a plug-in or add-on. The execution or presence of such a program may even be required by the web server for example (non compliant browsers wouldn't be served for example). The browser may agree to the presence of described steps, or not. For example, the presence and execution of such a program (through a marketed “ad secure/safe browsing” browser add-on) may be required by the advertiser in order to allow the delivery of web pages (in this case, the user of the browser may agree to the installation of such an add-on for example). It may also be implemented in a form of malware, which will execute said steps without the consent of the user of the browser. In another embodiment, it may also correspond to the implementation of the present invention in a proprietary browser (over which the user has little if no control).

FIG. 9c illustrates more complex cases, since the proxy server may act as a malware for example (man-in-the middle attack, for securing the display of advertisements, eventually against the willingness of the browser, or without its consent). According to other embodiments, it also illustrates a possible mutualisation of proxy servers through the network, or the proxy acting as an on-demand resource for the web server and offering reliable access to Internet for the web browser.

While the invention has been particularly shown and described with reference to a preferred embodiment, it will be understood that various changes in form and detail may be made therein without departing from the spirit, and scope of the invention.

There is provided a system to secure the display of advertisements. The method involves a web server, a proxy server and a client browser. In response to a first client browser query, the proxy server requests the corresponding markup file from the web server; upon reception of said markup file, the proxy server interprets said markup file in a viewer or browser and transforms the markup file into an image. The proxy server then constructs a modified markup file containing said image and light reengineered scripting language code, adapted to encode links and input fields. In the end, the client web browser interprets the modified markup file.

According to another embodiment, there is disclosed a method to view internet content, an image being rendered at a remote proxy server from the entire webpage which the remote proxy server retrieves from the Internet in response to the request, the web page containing said image and a new markup file scripting language code preserving the user interactivity.

According to yet another embodiment, there is disclosed a proxy internet browsing method according to which the proxy server sends image data representing the site to be browsed to a standard web browser on the users machine for display, and associated data instructions which re-encodes the user-interactivity.

At this stage, several observations are formulated regarding the scope of protection of the present invention.

In an embodiment, a markup file is an HTML (hyper-text markup language) or PHP page, but it is observed that the present invention addresses much wider cases. Indeed, the disclosure equally applies to other environments than the World Wide Web. It is thus intended that the scope of the invention covers all forms of electronic communications.

By definition, the disclosed technique applies for any kind of markup file, whatever is the environment. For example, the technique applies to WML pages, in mobile/wireless environments. The invention covers all known markup languages, as well as other systems explicitly designed to support descriptive markup languages. It is observed that most browsers natively support a variety of formats in addition to HTML, and can be extended to support more through the use of plug-in. Similarly the disclosure can be applied to many technologies including any now known or later developed web interface development technologies.

The described approach is not restricted to pure web environments; for example electronic messaging can implement embodiments of the invention (email clients do receive a lot of advertisements, whose effective display is intended to be secured by senders). Emails (electronic messages), since they can be in HTML format, are then also covered. According to certain embodiments, the disclosure also applies to application suites rather than merely web browsers: applications also can embed advertisements. For example, advertisements can be embedded in pdf viewers (pdf is a de facto standard and advertisements can be adapted to the final user according to the context and contents of the pdf file, among other parameters). According to the paradigm SaaS/Software as a Service, software is delivered through the Internet and any software application can appear as markup files (HTML pages). Similarly, gaming environments are more and more provided with embedded advertisements. Adblocking techniques could emerge in these environments and the present disclosure would enable to secure the display of advertisements. The present disclosure indeed addresses all viewers (content from a document may be rendered on a “content rendering application or device”. Examples of content rendering applications include an Internet browser, a media player (e.g., an MP3 player, a streaming audio file player, etc.), a viewer (e.g., a pdf reader), etc.)

According to certain embodiments, the present disclosure is very valuable to secure so-called mashups. Mashups mix and merge contents (data and code) from multiple content providers in a user's browser, to provide high-value web applications. Web applications increasingly rely on extensive scripting on the client-side (browser) using a readily available client-side script libraries (and programming paradigm such as AJAX). Mashup developers typically use a web application proxy server which fetches the content from different servers and serves it to the mashup or by directly including code from different origins. By separating and gathering contents, there are risks that enclosed or attached advertisements will be removed or skipped. Native security models of common browser platforms allow content to be separated, i.e., advertisements to be removed. By using the disclosed mechanism of image generation, according to certain embodiments, it is possible to make content non-separable (encapsulating contents), and following to secure the display of advertisements in these mashups environment, too. Associated to these image generation techniques, further code rewriting mechanisms can use script rewriting which can make a combination of static analysis and dynamic code rewriting (due to the self-modifying nature of some scripts), operations being performed in a rewriting proxy.

More generally, the described mechanism of scripting language code reengineering in addition to the generation of images applies to any situation where a distinction can be made between visualization and programming. Image mapping/generation will always be possible through analogue capture or video buffer access. Following, the present description discloses a technique that can be applied every time the underlying programming code can be accessed (since it enables to secure revenue stream, this will be more likely the common case). If code elements (underlying program and instructions) can be accessed (for example thanks to an API), then they can be modified (even in real-time) and the proposed mechanism can secure the display of advertisements. Even if the underlying program cannot be accessed, it can be learned, simulated, anticipated, computed, etc. Following, re-programming can also be reached (a step of learning has to be added to the present range of solutions).

The invention can take form of an entirely hardware embodiment, an entirely software embodiment or an embodiment containing both hardware and software elements. In an embodiment, the invention is implemented in software, which includes but is not limited to firmware, resident software, microcode, etc. In a high performance system, a hardware implementation of the code reengineering bundled with image generation processing may prove advantageous for example.

Furthermore, the invention can take the form of a computer program product accessible from a computer-usable or computer-readable medium providing program code for use by or in connection with a computer or any instruction execution system. For the purposes of this description, a computer-usable or computer-readable can be any apparatus that can contain, store, communicate, or transport the program for use by or in connection with the instruction execution system, apparatus, or device.

1. A method of handling an interpreted markup file, wherein the interpreted markup file comprises a set of displayable elements including input fields and links and an original scripting language code, the method comprising:
converting the set of displayable elements of the interpreted markup file to an image;
identifying at least one of the input fields or links in the markup file; and
replacing the original scripting language code by a modified scripting language code, the modified scripting language code being obtained by converting at least one link into markup tags or by converting at least one input field into a markup tag associating at least a part of the image to an input field.

2. The method of claim 1, further comprising:
altering the image by distorting, greyscaling, re-encoding, resizing, noising, discretizing, resampling or scrambling.

3. The method of claim 1, wherein the image is further divided into a plurality of sub-images.

4. The method of claim 3, further comprising:
altering one of the plurality of sub-images by distorting, greyscaling, re-encoding, resizing, noising, discretizing, resampling or scrambling.

5. The method of claim 1, further comprising:
constructing a modified markup file containing the image and the modified scripting language code.

6. The method of claim 3, further comprising:
constructing a modified markup file containing the plurality of sub-images and the modified scripting language code.

7. The method of claim 5, further comprising:
interpreting the modified markup file.

8. The method of claim 5 wherein the markup file or the modified markup file is an HTML or XML file.

9. A computer program stored on a computer readable medium, which when executed by a computer device, handles an interpreted markup file, wherein the interpreted markup file comprises a set of displayable elements including input fields and links and an original scripting language code, the computer program comprising instructions for:
converting the set of displayable elements of the interpreted markup file to an image;
identifying at least one of the input fields or links in the markup file; and
replacing the original scripting language code by a modified scripting language code, the modified scripting language code being obtained by converting at least one link into markup tags or by converting at least one input field into a markup tag associating at least a part of the image to an input field.

10. A system for handling an interpreted markup file, wherein the interpreted markup file comprises a set of displayable elements including input fields and links and an original scripting language code, comprising:
a system for converting the set of displayable elements of the interpreted markup file to an image;
a system for identifying at least one of the input fields or links in the markup file; and
a system for replacing the original scripting language code by a modified scripting language code, the modified scripting language code being obtained by converting at least one link into markup tags or by converting at least one input field into a markup tag associating at least a part of the image to an input field.

11. The system of claim 10, further comprising:
a system for altering the image by distorting, greyscaling, re-encoding, resizing, noising, discretizing, resampling or scrambling.

12. The system of claim 10, further comprising:
a system for dividing the image into a plurality of sub-images.

13. The system of claim 12, further comprising:
a system for altering one of the plurality of sub-images by distorting, greyscaling, re-encoding, resizing, noising, discretizing, resampling or scrambling.

14. The system of claim 10, further comprising:
a system for constructing a modified markup file containing the image and the modified scripting language code.

15. The system of claim 12, further comprising:
a system for constructing a modified markup file containing the plurality of sub-images and the modified scripting language code.

16. The system of claim 15, further comprising:
a system for interpreting the modified markup file.

17. The system of claim 15 wherein the markup file or the modified markup file is an HTML or XML file.
